(19) United States
(12) Patent Application Publication
(10) Pub. No.: US 2022/0272212 A1
(43) Pub. Date: Aug. 25, 2022

(54) COMMUNICATION SYSTEM, METHOD FOR CONTROLLING COMMUNICATION SYSTEM, AND INFORMATION PROCESSING DEVICE

(71) Applicant: SEIKO EPSON CORPORATION, Tokyo (JP)

(72) Inventors: Hirohiko KIHARA, Matsumoto-shi (JP); Toshiki FUJIMORI, Chino-shi (JP); Mitsuru KUBOTA, Matsumoto-shi (JP); Shun IMAI, Matsumoto-shi (JP)

(73) Assignee: SEIKO EPSON CORPORATION, Tokyo (JP)

(21) Appl. No.: 17/675,212

(22) Filed: Feb. 18, 2022

(30) Foreign Application Priority Data
Feb. 19, 2021 (JP) 2021-025303

(51) Int. Cl. H04N 1/00; G06F 8/61

(52) U.S. Cl. CPC H04N 1/00214; H04N 1/00315; G06F 8/61; H04N 2201/0015

(57) ABSTRACT

A communication system includes an information processing device executing processing of controlling a wireless communication device to start transmitting image data to a receiving device, when detecting coupling of the wireless communication device; and the wireless communication device establishing, when coupled to the information processing device communication with the receiving device, and transmitting the image data from the information processing device to the receiving device according to the control.

The present application is based on, and claims priority from JP Application Serial Number 2021-025303, filed Feb. 19, 2021, the disclosure of which is hereby incorporated by reference herein in its entirety.

### BACKGROUND

### 1. Technical Field

The present disclosure relates to a communication system, a method for controlling a communication system, an information processing device, and a wireless communication device.

### 2. Related Art

A technique for transmitting an image to a wireless projector from a personal computer is known.

For example, JP-A-2012-19316 discloses that an image transmission application program in a memory of a wireless LAN device with a built-in memory that is coupled to a personal computer is executed to transmit an image to a wireless projector from the personal computer.

However, in the technique described in JP-A-2012-19316, the application program needs to be read every time the wireless LAN device with the built-in memory is coupled to the personal computer. Therefore, it may take some time to start the application program. The wireless LAN device with the built-in memory is equivalent to an example of a wireless communication device. Also, since the application program stored in the wireless LAN device with the built-in memory is used, the application program may not be of a version that is suitable for software such as the OS (operating system) of the personal computer.

### SUMMARY

A communication system according to an aspect of the present disclosure includes an information processing device, and a wireless communication device attached to the information processing device. The information processing device includes a coupling detection unit detecting coupling of the wireless communication device, and a transmission unit causing the wireless communication device to transmit image data to a receiving device. When the coupling detection unit detects the coupling of the wireless communication device, the transmission unit causes the wireless communication device to start transmitting the image data to the receiving device. When coupled to the information processing device, the wireless communication device establishes communication with the receiving device and transmits the image data from the information processing device to the receiving device.

A method for controlling a communication system according to another aspect of the present disclosure includes an information processing device, and a wireless communication device attached to the information processing device. The method includes: causing the information processing device to cause the wireless communication device to start transmitting image data to a receiving device, when detecting coupling of the wireless communication device; and causing the wireless communication device to establish communication with the receiving device and transmit the image data from the information processing device to the receiving device, when coupled to the information processing device.

An information processing device according to still another aspect of the present disclosure includes a coupling detection unit detecting coupling of a wireless communication device, and a transmission unit causing the wireless communication device to transmit image data to a receiving device. When the coupling detection unit detects the coupling of the wireless communication device, the transmission unit causes the wireless communication device to start transmitting the image data to the receiving device.

A wireless communication device according to still another aspect of the present disclosure is attached to an information processing device and includes a memory storing link information representing an area in a server device where a control program is stored. The control program causes a processor of the information processing device to function as a coupling detection unit detecting coupling of the wireless communication device, and a transmission unit causing the wireless communication device to transmit image data to a receiving device.

### BRIEF DESCRIPTION OF THE DRAWINGS

FIG. 1 shows an example of the configuration of a communication system according to a first embodiment.

FIG. 2 shows an example of the configuration of a personal computer according to the embodiment.

FIG. 3 shows an example of the configuration of a wireless dongle according to the embodiment.

FIG. 4 is a flowchart showing an example of processing by a control unit and a dongle control unit.

FIG. 5 is a flowchart showing an example of processing by the control unit.

FIG. 6 shows an example of the configuration of a communication system according to a second embodiment.

### DESCRIPTION OF EXEMPLARY EMBODIMENTS

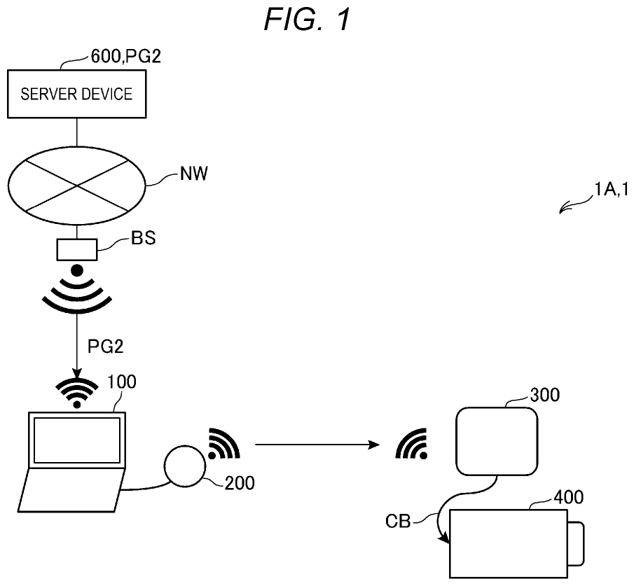

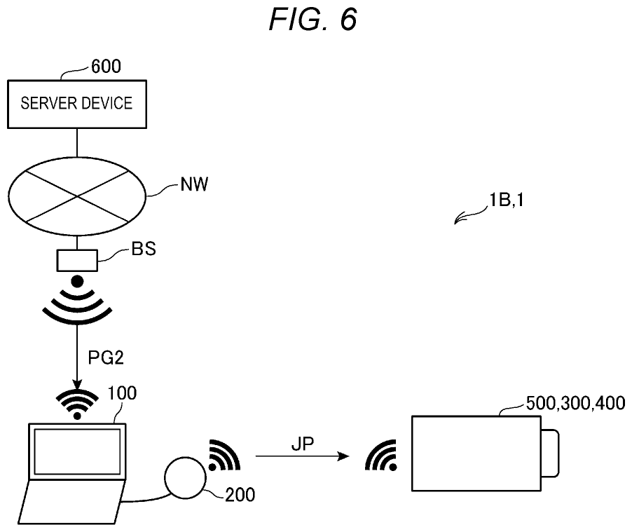

Embodiments will now be described with reference to the drawings. A communication system 1 according to the embodiments includes a communication system 1A according to a first embodiment described with reference to FIG. 1 and a communication system 1B according to a second embodiment described with reference to FIG. 6.

FIG. 1 shows an example of the configuration of the communication system 1A according to the first embodiment. The communication system 1A has a personal computer 100, a wireless dongle 200, a receiving device 300, a projector 400, and a server device 600.

The personal computer 100 is configured in such a way that the wireless dongle 200 can be attached to and removed from the personal computer 100. The personal computer 100 downloads a second control program PG2 from the server device 600 via the wireless dongle 200. The personal computer 100 is coupled in such a way as to be able to wirelessly communicate with the receiving device 300, for example, in conformity with the Wi-Fi (trademark registered) standard via the wireless dongle 200. The personal computer 100 transmits image data JP to the receiving device 300.

The personal computer 100 is equivalent to an example of the □information processing device□.

The second control program PG2 is equivalent to an example of the □control program□.

When the wireless dongle 200 is attached to the personal computer 100, the personal computer 100 is coupled in such a way as to be able to wirelessly communicate with the server device 600, for example, in conformity with the Wi-Fi (trademark registered) standard. When the wireless dongle 200 is attached to the personal computer 100, the personal computer 100 is also coupled in such a way as to be able to wirelessly communicate with the receiving device 300, for example, in conformity with the Wi-Fi (trademark registered) standard.

The wireless dongle 200 is equivalent to an example of the □wireless communication device□.

The receiving device 300 is coupled in such a way as to be able to wirelessly communicate with the wireless dongle 200, for example, in conformity with the Wi-Fi (trademark registered) standard. The receiving device 300 receives the image data JP from the wireless dongle 200.

The receiving device 300 is also coupled in such a way as to be able to communicate with the projector 400, for example, in conformity with the HDMI (High-Definition Multimedia Interface, trademark registered) standard. The receiving device 300 is coupled in such a way as to be able to communicate with the projector 400 via an HDMI cable CB.

The projector 400 receives the image data JP from the receiving device 300 and projects an image corresponding to the image data JP onto a screen.

The server device 600 is coupled in such a way as to be able to communicate with the personal computer 100 via a network NW. The server device 600 stores the second control program PG2 and transmits the second control program PG2 to the personal computer 100 in response to a request by the personal computer 100.

The network NW is the internet, for example. The network NW may be a LAN (local area network) or a WAN (wide area network).

The network NW is coupled to a wireless base station BS. The wireless base station BS is coupled in such a way as to be able to wirelessly communicate with the personal computer 100, for example, in conformity with the Wi-Fi (trademark registered) standard.

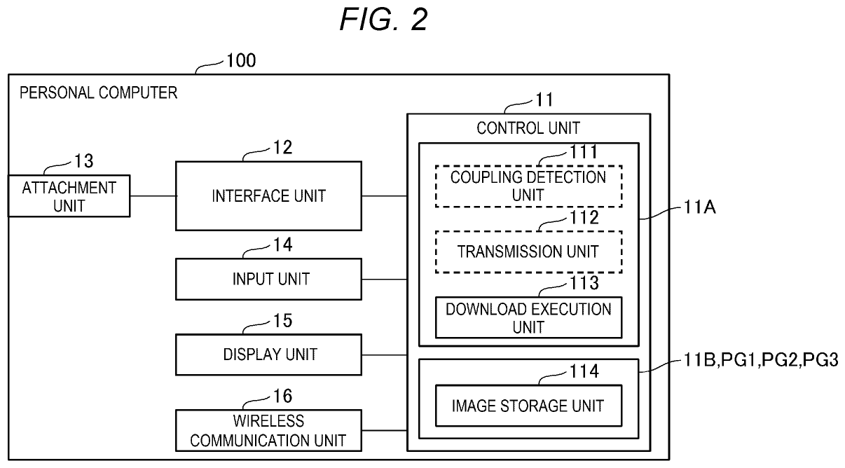

The configuration of the personal computer 100 will now be described with reference to FIG. 2. FIG. 2 shows an example of the configuration of the personal computer 100 according to this embodiment.

As shown in FIG. 2, the personal computer 100 has a control unit 11, an interface unit 12, an attachment unit 13, an input unit 14, a display unit 15, and a wireless communication unit 16.

The control unit 11 has a processor 11A such as a CPU (central processing unit) or an MPU (micro-processing unit), and a memory 11B such as a ROM (read-only memory) or a RAM (random-access memory). The control unit 11 controls each part of the personal computer 100.

The memory 11B stores a first control program PG1, the second control program PG2, and a third control program PG3.

The interface unit 12 has an interface circuit and couples together the wireless dongle 200 attached to the attachment unit 13 and the control unit 11 in such a way as to be able to communicate with each other.

The attachment unit 13 is configured in such a way that the wireless dongle 200 can be attached to and removed from the attachment unit 13. The attachment unit 13 functions as a USB (Universal Serial Bus) port, for example. That is, the attachment unit 13 communicates with the wireless dongle 200 in conformity with the USB standard.

The input unit 14 has an input mechanism such as a keyboard and a mouse provided in the personal computer 100. The input unit 14 detects an operation to the input mechanism by a user and outputs an operation signal corresponding to the operation, to the control unit 11. The control unit 11 executes processing corresponding to the operation by the user, based on the input from the input unit 14.

The display unit 15 has an LCD (liquid crystal display) or the like, for example, and displays an image on the LCD under the control of the control unit 11.

The wireless communication unit 16 has a wireless communication circuit supporting the Wi-Fi (trademark registered) standard, for example, and is coupled in such a way as to be able to wirelessly communicate with the wireless base station BS in conformity with the Wi-Fi (trademark registered) standard, according to an instruction from the control unit 11.

Functional units provided in the control unit 11 of the personal computer 100 will now be described.

The control unit 11 has a coupling detection unit 111, a transmission unit 112, a download execution unit 113, and an image storage unit 114, as functional units.

Specifically, the processor 11A executes the first control program PG1 stored in the memory 11B and thus causes the memory 11B to function as the image storage unit 114. The processor 11A also executes the second control program PG2 stored in the memory 11B and thus functions as the coupling detection unit 111 and the transmission unit 112. The processor 11A also executes the third control program PG3 stored in the memory 11B and thus functions as the download execution unit 113.

When the second control program PG2 is downloaded to the memory 11B, the processor 11A executes the second control program PG2 and thus functions as the coupling detection unit 111 and the transmission unit 112. That is, when the second control program PG2 is downloaded to the memory 11B, the second control program PG2 is installed in the control unit 11.

When the second control program PG2 is not stored in the memory 11B, the coupling detection unit 111 and the transmission unit 112 do not exist as functional units. Therefore, the coupling detection unit 111 and the transmission unit 112 are indicated by dashed lines in the illustration.

The image storage unit 114 stores the image data JP. The image data JP includes, for example, slide image data, and dynamic image data such as a movie.

The coupling detection unit 111 detects coupling of the wireless dangle 200. Specifically, the coupling detection unit 111 determines whether the wireless dongle 200 is attached to the attachment unit 13 or not.

The coupling detection unit 111 also acquires ID information identifying the wireless dongle 200, for example, so-called vendor ID information, from the wireless dongle 200, and determines whether the wireless dongle 200 attached to the attachment unit 13 is an adequate wireless dongle or not.

When determining that the wireless dongle 200 is not an adequate wireless dongle, the coupling detection unit 111 blocks the coupling to the wireless dongle 200. When determining that the wireless dongle 200 is an adequate wireless dongle, the coupling detection unit 111 couples the wireless dongle 200 in such a way as to be able to communicate.

The transmission unit 112 causes the wireless dongle 200 to transmit the image data JP stored in the image storage unit 114 to the receiving device 300.

When the coupling detection unit 111 detects the coupling of the wireless dongle 200, the transmission unit 112 causes a wireless communication unit 23 of the wireless dongle 200 to establish communication with the receiving device 300. The transmission unit 112 then causes the wireless dongle 200 to start transmitting the image data JP to the receiving device 300.

The transmission unit 112 also starts the transmission of the image data JP to the receiving device 300 in response to an instruction by the user to the input unit 14.

When recognizing the wireless dongle 200 as a mass storage, the control unit 11 displays an icon representing link information JL on the LCD of the display unit 15.

When the icon representing the link information JL displayed on the display unit 15 is clicked by the user, the download execution unit 113 downloads the second control program PG2 from a storage area in the server device 600 corresponding to the link information JL.

The download execution unit 113 stores the downloaded second control program PG2 in the memory 11B.

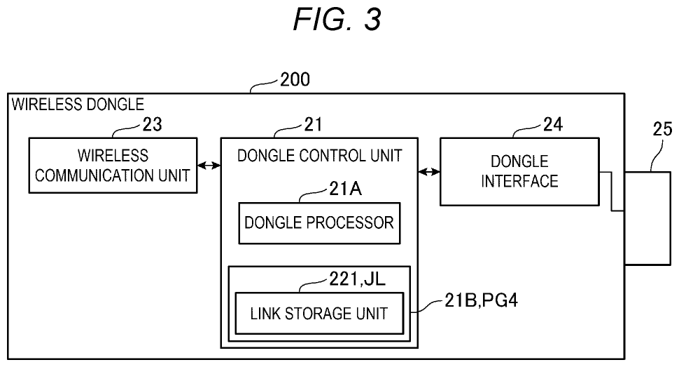

The configuration of the wireless dongle 200 will now be described with reference to FIG. 3. FIG. 3 shows an example of the configuration of the wireless dongle 200 according to this embodiment.

As shown in FIG. 3, the wireless dongle 200 has a dongle control unit 21, the wireless communication unit 23, a dongle interface unit 24, and a USB terminal 25.

The USB terminal 25 is configured to be attached to and removed from the attachment unit 13 of the personal computer 100.

The dongle interface unit 24 is coupled to each of the USB terminal 25 and the dongle control unit 21. The dongle interface unit 24 has an interface circuit and couples together the control unit 11 of the personal computer 100 and the dongle control unit 21 in such a way as to be able to communicate each other, for example, in conformity with the USB standard.

The wireless communication unit 23 establishes communication with the receiving device 300 according to an instruction from the dongle control unit 21 or the control unit 11. The wireless communication unit 23 couples to the receiving device 300 in such a way as to be able to communicate.

The dongle control unit 21 controls the operation of each of the wireless communication unit 23 and the dongle interface unit 24.

The dongle control unit 21 has a dongle processor 21A such as a CPU or an MPU, and a dongle memory 21B such as a ROM or a RAM. The dongle control unit 21 controls each part of the wireless dongle 200. The dongle memory 21B stores a fourth control program PG4.

The dongle processor 21A executes the fourth control program PG4 stored in the dongle memory 21B and thus controls each part of the wireless dongle 200.

The dongle memory 21B is equivalent to an example of the □memory□.

The dongle control unit 21 has a link storage unit 221. Specifically, the dongle processor 21A executes the fourth control program PG4 and thus causes the dongle memory 21B to function as the link storage unit 221.

The link storage unit 221 stores the link information JL representing the link for acquiring the second control program PG2. The link information JL represents the area in the server device 600 where the second control program PG2 is stored.

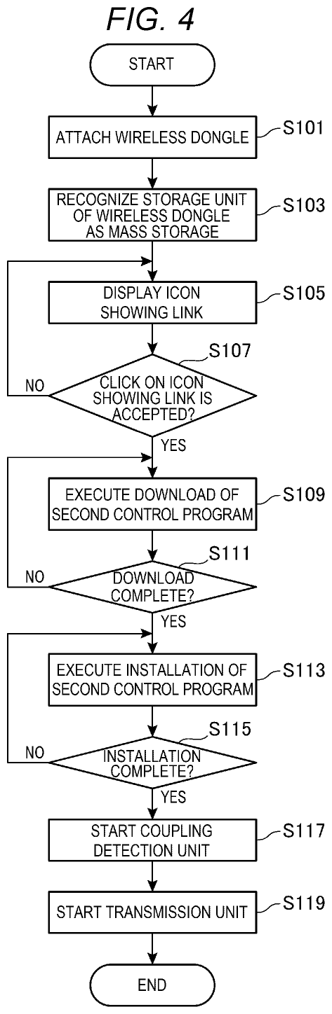

Processing by the control unit 11 and the dongle control unit 21 will now be described with reference to FIG. 4. FIG. 4 is a flowchart showing an example of the processing by the control unit 11 and the dongle control unit 21.

FIG. 4 shows the processing by the control unit 11 and the dongle control unit 21 in the case where the second control program PG2 is not stored in the memory 11B. Referring to FIG. 4, the case where the wireless dongle 200 attached to the attachment unit 13 is an adequate wireless dongle will be described.

As shown in FIG. 4, first, in step S101, the user attaches the wireless dongle 200 to the attachment unit 13 of the personal computer 100.

Next, in step S103, the control unit 11 recognizes the link storage unit 221 of the wireless dongle 200 as a mass storage. The mass storage is recognized by a device driver called USB mass storage class.

Next, in step S105, the control unit 11 displays an icon showing the link information JL on the LCD of the display unit 15.

Next, in step S107, the control unit 11 determines whether a click operation on the icon showing the link information JL is accepted from the user or not.

When the control unit 11 determines that a click operation on the icon showing the link information JL is not accepted from the user (NO in step S107), the processing returns to step S105. When the control unit 11 determines that a click operation on the icon showing the link information JL is accepted from the user (YES in step S107), the processing proceeds to step S109.

In step S109, the download execution unit 113 downloads the second control program PG2 from the storage area in the server device 600 corresponding to the link information JL.

Next, in step S111, the download execution unit 113 determines whether the download of the second control program PG2 is complete or not.

When the download execution unit 113 determines that the download of the second control program PG2 is not complete (NO in step S111), the processing returns to step S109. When the download execution unit 113 determines that the download of the second control program PG2 is complete (YES in step S111), the second control program PG2 is stored in the memory 11B and the processing proceeds to step S113.

In step S113, the control unit 11 installs the second control program PG2 in the personal computer 100.

Next, in step S115, the control unit 11 determines whether the installation of the second control program PG2 in the personal computer 100 is complete or not.

When the control unit 11 determines that the installation of the second control program PG2 in the personal computer 100 is not complete (NO in step S115), the processing returns to step S113. When the control unit 11 determines that the installation of the second control program PG2 in the personal computer 100 is complete (YES in step S115), the processing proceeds to step S117. On completion of the installation of the second control program PG2 in the personal computer 100, the coupling detection unit 111 and the transmission unit 112 are generated as functional units in the control unit 11. In other words, the processor 11A of the control unit 11 functions as the coupling detection unit 111 and the transmission unit 112. The content of the execution by the transmission unit 112 is equivalent to the processing.

In step S117, the control unit 11 starts the coupling detection unit 111.

Next, in step S119, the control unit 11 starts the transmission unit 112. The transmission unit 112 causes the wireless dongle 200 to transmit the image data JP stored in the image storage unit 114 to the receiving device 300. Subsequently, the processing ends.

In this way, when a click operation on the icon showing the link information JL is accepted from the user, the second control program PG2 is downloaded from the storage area in the server device 600. Therefore, the second control program PG2 can be easily downloaded.

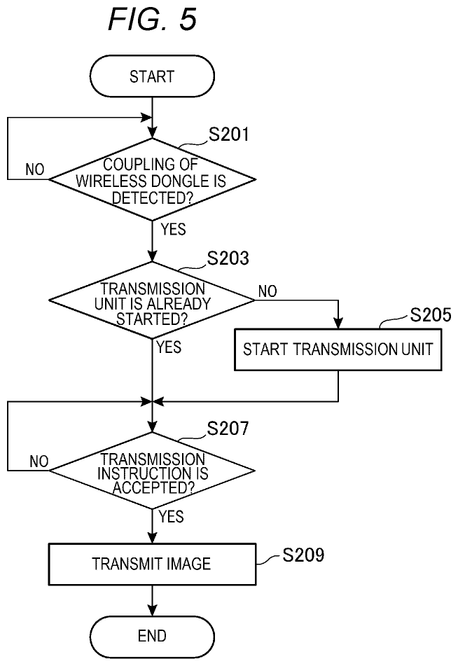

FIG. 5 is a flowchart showing an example of processing by the control unit 11.

FIG. 5 shows the processing by the control unit 11 in the case where the second control program PG2 has already been installed in the personal computer 100 and where the coupling detection unit 111 has already been started.

As shown in FIG. 5, in step S201, the coupling detection unit 111 determines whether the coupling of the wireless dongle 200 is detected or not.

When the coupling detection unit 111 determines that the coupling of the wireless dongle 200 is not detected (NO in step S201), the processing turns into awaiting state. When the coupling detection unit 111 determines that the coupling of the wireless dongle 200 is detected (YES in step S201), the processing proceeds to step S203.

Next, in step S203, the control unit 11 determines whether the transmission unit 112 is already started or not.

When the control unit 11 determines that the transmission unit 112 is already started (YES in step S203), the processing proceeds to step S207. When the control unit 11 determines that the transmission unit 112 is not started yet (NO in step S203), the processing proceeds to step S205.

In step S205, the control unit 11 starts the transmission unit 112. Subsequently, the processing proceeds to step S207.

In step S207, the transmission unit 112 determines whether a transmission instruction is accepted from the user or not. The transmission instruction is an instruction to transmit the image data JP stored in the image storage unit 114 to the receiving device 300.

When the transmission unit 112 determines that the transmission instruction is not accepted from the user (NO in step S207), the processing turns into a waiting state. When the transmission unit 112 determines that the transmission instruction is accepted from the user (YES in step S207), the processing proceeds to step S209.

In step S209, the transmission unit 112 causes the wireless dongle 200 to transmit the image data JP stored in the image storage unit 114 to the receiving device 300. Subsequently, the processing ends.

In this way, when the second control program PG2 has already been installed in the control unit 11, the time taken for startup can be reduced, compared with the case where the second control program PG2 is installed into the control unit 11.

FIG. 6 shows an example of the configuration of the communication system 1B according to the second embodiment.

As shown in FIG. 6, the communication system 1B has the personal computer 100, the wireless dongle 200, a projector 500, and the server device 600.

In FIG. 1, the receiving device 300 and the projector 400 are formed as separate devices. Meanwhile, the projector 500 shown in FIG. 6 is formed of the receiving device 300 and the projector 400 shown in FIG. 1 integrated together.

In the communication system 1A shown in FIG. 1, the wireless dongle 200 is coupled in such a way as to be able to wirelessly communicate with the receiving device 300. Meanwhile, the wireless dongle 200 shown in FIG. 6 differs in being coupled in such a way as to be able to wirelessly communicate with the receiving device 300 provided in the projector 500.

As described above with reference to FIGS. 1 to 6, the communication system 1 according to the embodiments has the personal computer 100 and the wireless dongle 200 attached to the personal computer 100. The personal computer 100 has the coupling detection unit 111 detecting the coupling of the wireless dongle 200, and the transmission unit 112 causing the wireless dongle 200 to transmit the image data JP to the receiving device 300. When the coupling detection unit 111 detects the coupling of the wireless dongle 200, the transmission unit 112 causes the wireless dongle 200 to start transmitting the image data JP to the receiving device 300. When coupled to the personal computer 100, the wireless dongle 200 establishes communication with the receiving device 300 and transmits the image data JP from the personal computer 100 to the receiving device 300.

In this configuration, when the coupling detection unit 111 detects the coupling of the wireless dongle 200, the transmission unit 112 causes the wireless dongle 200 to start transmitting the image data JP to the receiving device 300. When coupled to the personal computer 100, the wireless dongle 200 establishes communication with the receiving device 300 and transmits the image data JP from the personal computer 100 to the receiving device 300.

Therefore, the second control program PG2 causing the processor 11A of the personal computer 100 to function as the coupling detection unit 111 and the transmission unit 112 need not be installed in the personal computer 100. Thus, the time taken for startup can be reduced, compared with the case where the second control program PG2 is installed in the personal computer 100.

In the communication system 1, in the case where the second control program PG2 causing the processor 11A of the personal computer 100 to function as the coupling detection unit 111 and the transmission unit 112 has not been installed in the personal computer 100, the wireless dongle 200 downloads the second control program PG2 from the server device 600, based on an instruction from the user, when the wireless dongle 200 is coupled to the personal computer 100.

In this configuration, in the case where the second control program PG2 has not been installed in the personal computer 100, the wireless dongle 200 downloads the second control program PG2 from the server device 600, based on an instruction from the user, when the wireless dongle 200 is coupled to the personal computer 100.

Therefore, when the second control program PG2 has not been installed in the personal computer 100, the second control program PG2 can be easily downloaded from the server device 600. Therefore, the convenience of the user can be improved.

In the communication system 1, the dongle memory 21B of the wireless dongle 200 stores the link information JL representing the area where the second control program PG2 is stored in the server device 600.

In this configuration, the dongle memory 21B of the wireless dongle 200 stores the link information JL representing the area where the second control program PG2 is stored in the server device 600.

Therefore, the download execution unit 113 accesses the area where second control program PG2 is stored in the server device 600, based on the link information JL. The download execution unit 113 downloads the second control program PG2 from the server device 600. Thus, the second control program PG2 can be easily downloaded from the server device 600.

In the communication system 1, when the coupling detection unit 111 detects the coupling of the wireless dongle 200, and based on an instruction from the user to start transmitting the image data JP, the transmission unit 112 causes the wireless dongle 200 to start transmitting the image data JP to the receiving device 300.

In this configuration, the transmission unit 112 causes the wireless dongle 200 to start transmitting the image data JP to the receiving device 300, based on an instruction from the user to start transmitting the image data JP.

Therefore, the user can start transmitting the image data JP to the receiving device 300 at a desired timing.

The method for controlling the communication system 1 according to the embodiments is a method for controlling a communication system having the personal computer 100 and the wireless dongle 200 attached to the personal computer 100. When detecting the coupling of the wireless dongle 200, the personal computer 100 causes the wireless dongle 200 to start transmitting the image data JP to the receiving device 300. When coupled to the personal computer 100, the wireless dongle 200 establishes communication with the receiving device 300 and transmits the image data JP from the personal computer 100 to the receiving device 300.

In this configuration, when detecting the coupling of the wireless dongle 200, the personal computer 100 causes the wireless dongle 200 to start transmitting the image data JP to the receiving device 300. When coupled to the personal computer 100, the wireless dongle 200 establishes communication with the receiving device 300 and transmits the image data JP from the personal computer 100 to the receiving device 300.

Therefore, the second control program PG2 causing the processor 11A of the personal computer 100 to function as the coupling detection unit 111 detecting the coupling of the wireless dongle 200 and as the transmission unit 112 causing the wireless dongle 200 to transmit the image data JP to the receiving device 300 need not be read into the personal computer 100. Thus, the time taken for startup can be reduced, compared with the case where the second control program PG2 is read into the personal computer 100.

The personal computer 100 according to the embodiments has the coupling detection unit 111 detecting the coupling of the wireless dongle 200, and the transmission unit 112 causing the wireless dongle 200 to transmit the image data JP to the receiving device 300. When the coupling detection unit 111 detects the coupling of the wireless dongle 200, the transmission unit 112 causes the wireless dongle 200 to start transmitting the image data JP to the receiving device 300.

In this configuration, when the coupling detection unit 111 detects the coupling of the wireless dongle 200, the transmission unit 112 causes the wireless dongle 200 to start transmitting the image data JP to the receiving device 300.

Therefore, the second control program PG2 causing processor 11A of the personal computer 100 to function as the coupling detection unit 111 and the transmission unit 112 need not be read into the personal computer 100. Thus, the time taken for startup can be reduced, compared with the case where the second control program PG2 is read into the personal computer 100.

The wireless dongle 200 according to the embodiments is the wireless dongle 200 attached to the personal computer 100. The wireless dongle 200 has the dongle memory 21B storing the link information JL representing the area in the server device 600 where the second control program PG2 is stored, the second control program PG2 causing the processor 11A of the personal computer 100 to function as the coupling detection unit 111 detecting the coupling of the wireless dongle 200 and as the transmission unit 112 causing the wireless dongle 200 to transmit the image data JP to the receiving device 300.

In this configuration, the wireless dongle 200 has the dongle memory 21B storing the link information JL representing the area in the server device 600 where the second control program PG2 is stored, the second control program PG2 causing the processor 11A of the personal computer 100 to function as the coupling detection unit 111 detecting the coupling of the wireless dongle 200 and as the transmission unit 112 causing the wireless dongle 200 to transmit the image data JP to the receiving device 300.

The download execution unit 113 accesses the area where the second control program PG2 is stored in the server device 600, based on the link information JL. The download execution unit 113 downloads the second control program PG2 from the server device 600. Thus, the second control program PG2 can be easily downloaded from the server device 600.

The embodiments simply represent one aspect of the present disclosure. Any modifications and applications can be made within the spirit and scope of the present disclosure.

For example, in the embodiments, a case where the information processing device is the personal computer 100 is described. However, this is not limiting. The information processing device may be a tablet terminal.

In the embodiments, a case where the personal computer 100 has the download execution unit 113 is described. However, this is not limiting. The wireless dongle 200 may have a download execution unit. In this case, the wireless communication unit 16 of the personal computer 100 is not needed.

In the embodiments, a case where the personal computer 100 stores the second control program PG2 is described. However, this is not limiting. The wireless dongle 200 may store the second control program PG2. In this case, the operation of storing the second control program PG2 in the personal computer 100 can be omitted.

Each functional unit shown in FIGS. 2 and 3 represents a functional configuration and is not particularly limited to any specific installation form. That is, individual pieces of hardware corresponding to individual functional units need not necessarily be installed. A single processor may be able to execute a program to implement functions of a plurality of functional units. In the embodiments, a part of the functions implemented by software may be implemented by hardware and a part of the functions implemented by hardware may be implemented by software. Also, any change can be made to specific details of the configuration of each of the other parts of the personal computer 100 and the wireless dongle 200 without departing from the spirit and scope of the present disclosure.

The processing steps in the flowcharts, for example, shown in FIGS. 4 and 5 are provided by splitting the processing according to the main processing content in order to facilitate understanding of the processing by the control unit 11 and the dongle control unit 21. The present disclosure is not limited by the way the processing is split into processing steps and the names thereof. Depending on the processing content, the processing may be split into further processing steps. Also, one processing step may be split to include further processing. The order of the processing may be suitably changed without affecting the spirit and scope of the present disclosure.

The functional blocks in the control unit 11 of the personal computer 100 can be implemented by causing the processor 11A of the control unit 11 to execute the first control program PG1 and the second control program PG2 stored in the memory 11B. The first control program PG1 and the second control program PG2 can be recorded in a computer-readable recording medium. As the recording medium, a magnetic or optical recording medium, or a semiconductor memory device can be used. Specifically, a portable recording medium such as a flexible disk, an HDD (hard disk drive), a CD-ROM (compact disk read-only memory), a DVD (digital versatile disc), a Blu-ray (trademark registered) disc, a magneto-optical disk, a flash memory or a card-type recording medium, or a fixed recording medium can be employed. The recording medium may also be a non-volatile storage device such as a RAM, a ROM or an HDD, which is an internal storage device provided in the personal computer 100. Also, the first control program PG1 and the second control program PG2 may be stored in a server device or the like, and the first control program PG1 and the second control program PG2 may be downloaded from the server device to the control unit 11 of the personal computer 100, thus implementing the functional blocks in the control unit 11 of the personal computer 100.

The functional blocks of the dongle control unit 21 of the wireless dongle 200 can be implemented by causing the dongle processor 21A of the dongle control unit 21 to execute the fourth control program PG4 stored in the dongle memory 21B. The fourth control program PG4 can be recorded in a computer-readable recording medium. As the recording medium, a magnetic or optical recording medium, or a semiconductor memory device can be used. Specifically, a portable recording medium such as a flexible disk, an HDD, a CD-ROM, a DVD, a Blu-ray (trademark registered) disc, a magneto-optical disk, a flash memory or a card-type recording medium, or a fixed recording medium can be employed. The recording medium may also be a non-volatile storage device such as a RAM or a ROM, which is an internal storage device provided in the wireless dongle 200. Also, the fourth control program PG4 may be stored in a server device or the like, and the fourth control program PG4 may be downloaded from the server device to the dongle control unit 21 of the wireless dongle 200, thus implementing the functional blocks in the dongle control unit 21 of the wireless dongle 200.

What is claimed is:

1. A communication system comprising:
an information processing device which executes processing of controlling a wireless communication device to start transmitting image data to a receiving device, when detecting coupling of the wireless communication device; and
the wireless communication device which establishes, when coupled to the information processing device, communication with the receiving device and transmits the image data from the information processing device to the receiving device according to the control.

2. The communication system according to claim 1, wherein
the information processing device includes a processor, and
if a control program causing the processor to execute the processing is not installed in the information processing device, the information processing device downloads the control program from a server device, based on an instruction from a user, when the wireless communication device is coupled to the information processing device.

3. The communication system according to claim 2, wherein
the wireless communication device includes a memory which stores link information representing an area where the control program is stored in the server device.

4. The communication system according to claim 1, wherein
when the coupling of the wireless communication device is detected and an instruction to start transmitting the image data in the processing, the information processing device controls the wireless communication device to start transmitting the image data to the receiving device, based on the instruction to start transmitting the image data.

5. A method for controlling a communication system,
the communication system including:
an information processing device; and
a wireless communication device coupled to the information processing device,
the method comprising:
controlling, by the information processing device, the wireless communication device to start transmitting image data to a receiving device, when detecting coupling of the wireless communication device;
establishing, by the wireless communication device, communication with the receiving device; and
transmitting, by the wireless communication device, the image data from the information processing device to the receiving device, when coupled to the information processing device.

6. An information processing device comprising:
a processor configured to, when detecting coupling of a wireless communication device, control the wireless communication device to start transmitting image data to a receiving device.
